(19) United States
(12) Patent Application Publication
(10) Pub. No.: US 2026/0100960 A1
(43) Pub. Date: Apr. 9, 2026

(54) MALICIOUS DOMAIN NAME DETECTION

(71) Applicant: British Telecommunications Public Limited Company, London Greater London (GB)

(72) Inventors: Sadiq SANI, London (GB); Aditya MANOCHA, London (GB)

(21) Appl. No.: 19/115,682

(22) PCT Filed: Sep. 8, 2023
(86) PCT No.: PCT/EP2023/074733

§ 371 Date: Mar. 26, 2025

(30) Foreign Application Priority Data
Sep. 28, 2022 (EP) 22198528.6
Sep. 28, 2022 (GB) 2214223.6

(51) Int. Cl. H04L 9/40; H04L 61/4511

(52) U.S. Cl. CPC H04L 63/1416; H04L 61/4511; H04L 63/0236; H04L 63/1441

(57) ABSTRACT

A computer-implemented method, computer system and computer program are provided for detecting malicious domain names from a set of candidate domain names based on a set of reference domain names. The method uses natural language processing to generate vector representations of the domain names, each vector representation representing a respective domain name in the set of candidate domain names and the set of reference domain names. The method clusters the vector representations to generate clusters of domain names, the domain names within each cluster being similar to each other. The method analyses the clusters of domain names to identify at least one cluster comprising at least one domain name belonging to the set of candidate domain names and at least one main name belonging to the set of reference domain names. The method provides an indication of one or more of the domain names in the set of candidate domain names included in the identified clusters as being malicious domain names.

### FIELD OF THE INVENTION

The present invention relates to network security. In particular, the present invention relates to the detection of malicious domain names.

### BACKGROUND TO THE INVENTION

Cybercriminals are increasingly using malicious domain names to facilitate attacks on computer systems and/or networks. A malicious domain name will typically be crafted by an attacker so as to appear like a legitimate domain name. For example, an attacker may seek to register a domain name that is very similar to a domain name of a reputable company, such that the malicious domain name is likely to be confused for the domain name of that company. Such a malicious domain name might then be used to facilitate attacks on unsuspecting victims. For example, the malicious domain name might be used as part of phishing campaign (or, alternatively, as part of a spear-phishing attack). Such phishing attacks might seek to extract information from victims, as is known to those skilled in the art. Additionally, or alternatively, the malicious domain name might be used for drive-by compromise attacks in which visitors to the malicious domain name are exposed to malicious code that exploits vulnerabilities of the visitor's computer system to download malware onto the computer system. Yet another use for malicious domain names is to enable malware that has already been installed on victim's computers to locate and communicate with command and control servers to enable exfiltration of data, provide instructions malware and/or provision additional functionality (e.g. through the download of additional malicious code) to the malware.

### SUMMARY OF THE INVENTION

It is generally considered to be fairly difficult to detect malicious domain names on the basis of the registered name alone. This is because it is generally believed that there is no underlying pattern to either genuine or malicious domain name registrations. As a result, attempts to train a classifier to classify a domain name as being either malicious or benign based solely on the registered name is generally believed to be unlikely to succeed.

In the case of malicious domain names that have been crafted to reflect well-known genuine domain names, it is noted that those genuine domain names are chosen based on the individual preferences and circumstances of the registerer and so do not tend to follow any underlying pattern. Similarly, since these malicious domain names are crafted to resemble such genuine domain names, they will also benefit from this general lack of underlying pattern.

Another approach that is commonly taken by attackers when crafting malicious domain names is to create malicious domain names which exploit themes that are likely to be popular with their intended victims. It is therefore common to find malicious domain names being registered that reflect recent events or trends. For example, the rise of interest in cryptocurrencies led to an increase in new malicious domain name registrations involving various cryptocurrency-related keywords. Similarly, with the outbreak of COVID-19 malicious domain names associated with keywords relating to COVID-19 started to increase. However, such malicious domain names are still unlikely to share any underlying pattern with other malicious domain names that were registered prior to such an event or trend taking place.

It is noted that there is a class of domain names, commonly referred to as algorithmically generated domains (which are generated by domain generating algorithms or DGAs) for which there may be underlying patterns that could be detected by a classifier. However, such malicious domain names only account for proportion of malicious domain name registrations, leaving a large number of malicious domain names that do not have such underlying patterns.

Existing approaches to detecting malicious domain names typically rely on examining the behaviours and patterns of communication associated with such domain names after they have started being actively used. However, this requires that the domain names are allowed to operate for a sufficient length of time to allow a sufficient volume of communications to take place before the malicious nature of the domain name can be determined. During this time, an attacker employing a malicious domain name is afforded a sufficient window of opportunity to achieve at least some of their objectives.

Accordingly, it would be desirable to allow detection of a malicious domain name from the registered name alone; that is, without needing to rely on any traffic occurring with the domain name before the domain name's malicious nature can be determined. This would allow the window of opportunity afforded to attackers to be reduced by enabling detection of a malicious domain name to occur much closer to its initial registration. Indeed, the detection may even be performed before an IP address is associated with the domain name.

In a first aspect of the invention, there is provided a computer-implemented method for detecting malicious domain names from a set of candidate domain names based on a set of reference domain names, the method comprising: using natural language processing to generate vector representations of the domain names, each vector representation representing a respective domain name in the set of candidate domain names and the set of reference domain names; clustering the vector representations to generate clusters of domain names, the domain names within each cluster being similar to each other; analysing the clusters of domain names to identify at least one cluster comprising at least one domain name belonging to the set of candidate domain names and at least one domain name belonging to the set of reference domain names; and providing an indication of one or more of the domain names in the set of candidate domain names included in the identified clusters as being malicious domain names.

Through this clustering approach, the invention detects domain names that are similar to those that have already been registered. These domain names are likely to be malicious.

The set of reference domain names may be a set of domain names that are known to be malicious. The method may add the indicated domain names to the set of reference domain names for use in a future iteration of the method.

By identifying domain names that are clustered around known malicious domain names, the invention enables detection of newly registered domain names that are likely to be malicious. Specifically, where malicious domain names are registered that exploit current events or themes of interest to intended victims, the discovery of initial malicious domain names exploiting a particular event or theme of interest can lead to the identification of large numbers of subsequent malicious domain names being registered to exploit that same event or theme through the application of this approach.

The set of reference domain names may be a set of domain names that are known to be benign.

By identifying domain names that are clustered around known benign (or genuine) domain names, the invention enables detection of newly registered domain names that are likely to be malicious. Specifically, where malicious domain names are registered that exploit a well-known domain name, those malicious domain names can be detected through the application of this approach.

The set of candidate domain names may be a set of domain names that have been registered within a predetermined preceding period of time, such as: a set of domain names registered in the preceding hour; a set of domain names registered in the preceding six hours; a set of domain names registered in the preceding twelve hours; a set of domain names registered in the preceding twenty four hours; or a set of domain names registered in the preceding forty eight hours.

The clustering may be performed using locality sensitive hashing. In particular, the clustering is performed using a random projection method of locality sensitive hashing. The number of random projections used for clustering may define a number of buckets that is substantially greater than a total number of domain names in the set of candidate domain names and the set of reference domains.

The method may further comprise, for each of the identified clusters, analysing the domains within that cluster that belong to the set of candidate domain names to determine a respective distance between each of those candidate domain names and each of the at least one domain names belonging to the set of reference domain names within that cluster, wherein the one or more of the domain names in the set of candidate domain names that are indicated as being malicious domain names are those for which the respective distance to at least one of the domain names belonging to the set of reference domain names within that cluster is less than a predetermined threshold.

The method may further comprise providing, for each of the domain names indicated as being malicious, indications of one or more, or all, of the domain names belonging to the set of reference domain names that belong to the same cluster as that domain name.

The method may further comprise causing one or more predetermined actions to be taken in respect of the indicated domain names to mitigate or prevent a threat posed by that domain name. The one or more predetermined actions may comprise one or more, or all, of: preventing resolution of DNS queries from computer systems within a network for any of the indicated domain names; blocking traffic from the network destined to any IP addresses associated with the indicated domain names; blocking traffic to the network originating from any IP addresses associated with the indicated domain names; and monitoring the network to identify any computer systems within the network that are in communication with any IP addresses associated with the indicated domain names.

In a second aspect of the invention, there is provided a computer system comprising a processor and a memory storing computer program code for performing a method according to the first aspect.

In a third aspect of the invention, there is provided a computer program which, when executed by one or more processors, is arranged to carry out a method according to the first aspect.

### BRIEF DESCRIPTION OF THE FIGURES

Embodiments of the present invention will now be described by way of example only, with reference to the accompanying drawings, in which:

FIG. 1 is a block diagram of a computer system suitable for the operation of embodiments of the present invention.

FIG. 2 is a flowchart illustrating a method for identifying malicious domain names according to embodiments of the invention.

### DETAILED DESCRIPTION OF EMBODIMENTS

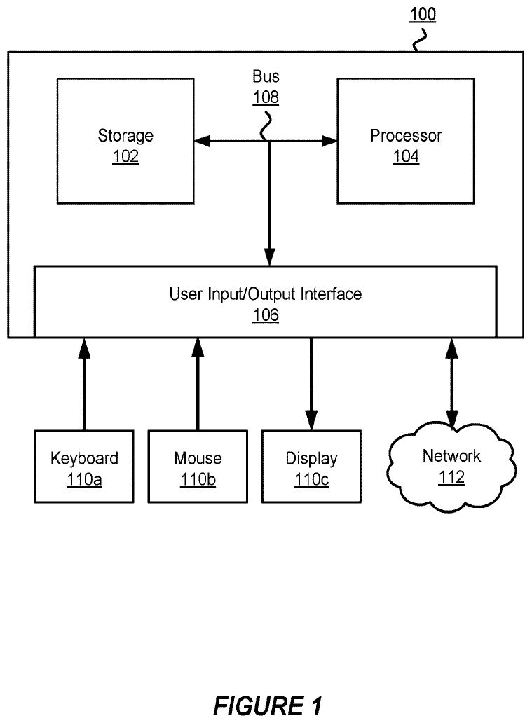

FIG. 1 is a block diagram of a computer system 100 suitable for the operation of embodiments of the present invention. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the invention, as discussed below (and accordingly configure the system 100 to be a system 100 according to an embodiment of the invention).

The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: a personal computer; a laptop; a tablet; a mobile telephone (or smartphone); a television set (or set top box); a games console; an augmented/virtual reality headset; a server; or indeed any other computing device with sufficient computing resources to carry out a method according to embodiments of this invention.

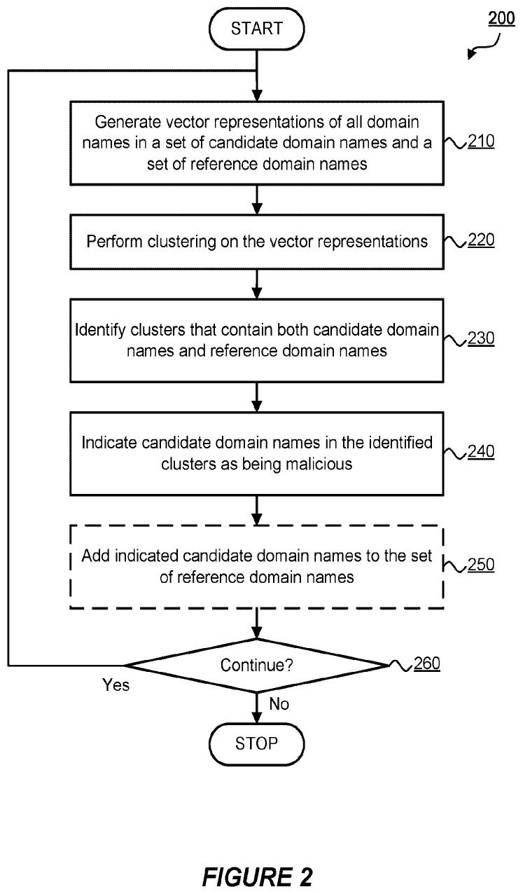

FIG. 2 is a flowchart illustrating a method 200 for detecting malicious domain names according to embodiments of the invention. The method 200 detects the malicious domain names from a set of candidate domain names based on a set of reference domain names.

In some cases, the set of reference domain names that are used by the method 200 may include domain names that are known to be malicious. For example, the set of reference domain names may include known malicious domain names retrieved from threat intelligence sources. Additionally, or alternatively, the set of reference domain names may include domain names that are known to be benign (e.g. well-known domain names belonging to reputable companies and/or individuals).

The set of candidate domain names may be any set of domain names from which it is desired to identify malicious domain names. In some cases, the set of domain names may be a set of a domain names that have been registered within a predetermined preceding period of time in order to detect malicious domain names that have been newly registered. For example, the set may consist of domain names that have been registered within the preceding hour, preceding six hours, preceding twelve hours, preceding twenty four hours or preceding forty eight hours.

The method 200 may be performed by any suitable computer system, such as the computer system 100 illustrated in FIG. 1. The method 200 starts with an operation 210.

At operation 210, the method 200 generates a vector representation of each of the domain names in the set of candidate domain names and the set of reference domain names. This pre-processing step takes each domain as a string input and outputs a vector representation of that domain that represents the lexical features of that domain. This can be achieved using any suitable natural language processing techniques, as will be understood by those skilled in the art. Specifically, each of the domain names is broken up into tokens (words) using a process called tokenisation. The tokens for all of the domain names taken as a whole (i.e. those in both the set of candidate domain names and the set of reference domain names) are combined to form a vocabulary. Each domain name is then represented by a vector having a dimension that is equal to the size of the vocabulary, whereby each element of the vector corresponds to an individual token in the vocabulary and has a non-zero value where that token is present in the domain.

As will be appreciated, where the method 200 is performed iteratively, the output from the tokenisation step may be cached for use in future iterations of the method. For example, the method 200 may store the tokens that are associated with each domain name in the set of reference domain names. Therefore, only the new domain names may need tokenising in subsequent iterations of the method 200 (that is, the domain names in the set of candidate domain names and any new reference domain names that have been added to the set of reference domain names since the previous iteration).

In some cases, prior to generating the vector representation of each domain name using natural language process, the top-level domain (TLD) is removed. There is a limited (finite) set of top-level domains (e.g. .com, net, .org, etc.) that are available for registration. Therefore, vast numbers of domain names are likely to share the same top-level domain and the top-level domain is unlikely to be of benefit in identifying similar domain names for the purposes of identifying malicious domain names. For example, the similarity of genuine (benign) domain names may be artificially increased simply by sharing the same top-level domain. Similarly, malicious domains may attempt to appear to be more convincing by simply registering the same second-level domain (and/or lower-level subdomains) with a different top-level domain. Accordingly, removing the top-level domain is likely to improve the results of the method 200.

In any case, having generated the vector representations of all the domain names, the method 200 proceeds to an operation 220.

At operation 220, the method 200 performs clustering based on the vector representations of the domain names. The two sets of domain names are essentially treated as a single set of domain names for this clustering process. That is to say, all of the domain names, including both those in the set of candidate domain names and the set of reference domain names are clustered. As will be understood by those skilled in the art, the output of this clustering process is the generation of clusters of domain names wherein all of the domain names in any particular cluster are similar to each other (or at least more similar to each other than to domain names not in that cluster).

The clustering that is performed by operation 220 has slightly different requirements than typical clustering applications. In particular, the method 200 is not concerned with attempting to place each domain name into a cluster, such as might be achieved through the use of k-means clustering. The method 200 is also not concerned with identifying large clusters of domain names (i.e. those having the largest numbers of domain names associated with them), such as might be achieved through the use of Density-Based Spatial Clustering of Applications with Noise (DBSCAN). Instead, the method is seeking to identify clusters of domain names that are very similar to each other-even if this means that only relatively few clusters are identified, that those clusters are relatively small and/or that the majority of the domain names being considered do not end up belonging to a cluster.

A suitable clustering technique for this purpose is Hierarchical Agglomerative Clustering (HAC), which treats each item as its own individual clusters and proceeds to merge the most similar pairs of clusters until a similarity threshold has been reached. However, HAC involves an exhaustive pairwise similarity computation between all domain names, which can result in long compute times when considering larger data sets.

In some cases, the method 200 may be used to analyse a large number of candidate domain names (and/or based on a large number of reference domain names). The use of HAC may result in large compute times in such cases. This may in turn result in a relatively large window of opportunity remaining for an attacker to utilise a malicious domain name due to the required compute time. Accordingly, in such cases, the technique of Locality Sensitive Hashing (LSH) may be employed to provide a computationally efficient way of performing the clustering for this application according to some embodiments of the invention, as will now be described.

Locality Sensitive Hashing (LSH) is an algorithm for assigning items into buckets using a hashing function, such that highly similar items have a high probability of being assigned to the same bucket. In other words, LSH assigns similar items to the same bucket and dissimilar items to different buckets. Although LSH was not traditionally designed for clustering, the buckets generated by LSH can be considered to be clusters for the purposes of this invention. In LSH, the n-dimensional space (where n is the size of the vector representations of the domain names—i.e. the size of the token vocabulary across the sets of domain names as a whole) can be partitioned by defining a number, k, of projection vectors. In some cases, these projection vectors can be randomly generated according to the random projection method of LSH. Each projection vector divides the space in 2, namely a positive side (represented by a 1) and a negative side (represented by a 0). Accordingly, k projection vectors will define 2^{k} buckets, each of which can be addressed by a k-bit binary number, whereby each bit of the number represents which side of the corresponding projection vector the bucket lies. The bucket to which a particular n-dimensional vector representation of a domain name lies in can be determined by evaluating the vector dot product between that vector representation and each of the k projection vectors in turn to generate a k-bit address of the bucket (i.e. with each bit in the address being a 1 where the vector dot product with the projection vector associated with that bit is positive and 0 where the dot product is negative or 0). Accordingly, when using LSH, each of the vector representations of the domain names only needs to be compared to each of the k projection vectors, as opposed to each of the vector representations of the other domain names. This provides greatly improved computational scalability which can allow more computationally efficient consideration of large numbers of domain names. It is also suited to distributed processing. Therefore, the use of LSH in this way can allow processing of large datasets in a shorter period of time (thereby limiting any window of opportunity for an attacker to utilise a malicious domain name).

Ideally, in order to ensure that only very similar domains are placed in the same bucket when using LSH, a relatively large number of buckets should be defined. In particular, the number of buckets that are defined is ideally substantially greater than the total number of domain names in the set of candidate domain names and the set of reference domain names combined. That is to say, a ratio of the number of buckets to the total number of domain names is greater than a predefined threshold. In experiments involving approximately 300,000 domain names, 32 random projections (providing 2³² buckets giving a ratio of number of buckets to total number of domain names of approximately 15000:1) was found to provide an effective way of processing the domain names in a timely manner. It is therefore expected that ratios of a similar magnitude are likely to yield effective results. In particular, by defining such a large number of buckets, the majority of buckets will be expected to be empty (i.e. having no domains mapped to them) while the remainder will generally only contain a single domain. Only where two domains are very similar are they likely to be mapped to the same bucket.

Although the use of HAC and LSH have been described above, it will be appreciated that any suitable clustering technique meeting the above-described requirements may be used instead.

In any case, having determined clusters of similar domain names from amongst the combined sets of candidate domain names and reference domain names, the method 200 proceeds to an operation 230.

At operation 230, the method 200 analyses the clusters of domain names to identify any clusters that contain both candidate domain names and reference domain names. That is to say, the method 200 identifies clusters that include at least one domain name belonging to the set of candidate domain names and at least one domain name belonging to the set of reference domain names. In other words, only clusters containing a mix of malicious domain names and candidate domain names are of interest. Any clusters that exclusively contain either malicious domain names or candidate domain names are disregarded. Having identified those clusters having a mix of different types of domain name, the method 200 proceeds to an operation 240.

At operation 240, the method 200 provides an indication of those candidate domain names in the identified clusters that are considered to be malicious.

In some cases, where the clustering technique that is performed ensures a minimum level of similarity between the domain names in a cluster, the method 200 may simply indicate that all of the candidate domain names that are in the same cluster as one or more of the reference domain names are considered to be malicious (as each of the candidate domain names will be at least that minimum level of similarity to a reference domain name and so are likely to be malicious).

However, in other cases, the method 200 may perform further analysis on the domain names within each of the identified clusters to check whether each of the candidate domain names in a cluster has at least the minimum required level of similarity to at least one of the reference domain names in that cluster. This can be achieved by determining a respective distance between each of the those candidate domain names and the reference domain names within the same cluster until it has been determined that the candidate domain name is sufficiently similar to at least one of the reference domain names that it is likely to be malicious (i.e. where the respective distance to at least one of the reference domain names is less than a predetermined distance). If at least one of the reference domain names within the cluster is sufficiently similar (i.e. has a respective distance from the candidate domain name that is less than the predetermined threshold), that candidate domain name is identified as being likely to be malicious. On the other hand, if none of the reference domain names within the cluster are closer than the predetermined threshold to a candidate domain name, that candidate domain name may be identified as being non-malicious or benign that is, it may not appear amongst those candidate domain names that are indicated as being malicious at operation 240.

This further analysis may be beneficial, for example, when used with the LSH approach to clustering outlined above. This is because, although the LSH clustering will result in similar domain names being in the same cluster, there is no strict similarity threshold that is imposed by this clustering technique. It may therefore be desirable to carry out this further analysis to ensure that the candidate domain names within a particular cluster are actually sufficiently similar to a reference domain name before they are indicated as being malicious.

As will be appreciated, carrying out such a check at this stage allows more computationally expensive metrics to be used because there will be a much more limited number of domain names under consideration (i.e. those in a particular cluster, not the entire combined set of candidate and reference domain names). Any suitable distance metric may be used and may be based either upon the string representations of the domain names or the vector representations of the domain names that was generated at operation 210. Indeed, in some cases, multiple distance metrics may be used. In such cases a candidate domain name may be considered to be malicious if it is below a predetermined threshold distance to a reference domain name according to any of the distance metrics. Of course, in some cases, a different respective predetermined threshold may be used with respect to each of the distance metrics (e.g. a candidate domain name may be considered to be malicious if a distance to a reference domain according to a first distance metric is within a first predetermined distance and/or a distance to a reference domain according to a second distance metric is within a second predetermined distance).

As an example, two suitable distance metrics that may be employed for this further analysis are the Levenshtein distance and the Dice distance may be used. The Levenshtein distance (also referred to as the ‘edit distance’) measures the number of insertions, deletions and substitutions that are need to make two strings equal. This is ideal for measuring how similar two domains are. However, it results in a large distance between two (otherwise identical) strings whose words have been placed in a different order. Since it is a common technique for attackers to change the order of words when generating malicious domain names, it would be beneficial to include an additional metric that is unaffected (or at least is less affected) by such changes. The Dice distance measures the overlap in two sets, regardless of any ordering of items within those sets. The Dice distance can be calculated from the set of tokens present in each domain name, as determined during operation 210. Domain names can be considered as a set of tokens (obtained from the tokenisation step of operation 210). The Dice distance therefore will measure the similarity between two domains based on the overlap in their tokens regardless of the ordering of those tokens. By using the Levenshtein and Dice metrics together, it is possible to identify those candidate domain names within a cluster that are most similar to the reference domain names within that cluster. Of course, it will be appreciated that other techniques for evaluating similarity between the domain names within the cluster may be used instead.

In some cases, in addition to providing an indication of those candidate domain names in the identified clusters that are considered to be malicious, the method 200 may also provide indications of one or more, or all, of the reference domain names within that same cluster. This additional information can help demonstrate (or explain) why a particular candidate domain name has been indicated as being malicious. For example, the method 200 may provide, for each of the candidate domain names that are indicated as being malicious, an indication of the closest reference domain name within the cluster. Alternatively, the method 200 may provide, for each of the candidate domain names that are indicated as being malicious, an indication of all reference domain names that are sufficiently similar to that candidate domain name within the cluster (i.e. those reference domain names for which a distance metric is below a predetermined threshold). The method 200 may also provide other information relating to the similarity which may be useful in demonstrating why a particular candidate domain name has been indicated as malicious, such as one or more of the distance measures between the candidate domain name and the reference domain names in the cluster.

Having provided an indication of those candidate domain names in the identified clusters that are considered to be malicious, the method 200 may, in some cases, proceed to an optional operation 250. However, where optional operation 250 is not present, the method 200 proceeds to an operation 260.

At optional operation 250, the method 200 may add the indicated candidate domain names to the set of reference domain names. In particular, where known malicious domain names are included in the set of reference domain names, the candidate domain names that have been identified as being malicious by method 200 may be added to the set of reference domain names ready for use by a future iteration of the method. This may enable better detection of other malicious domain names in the future. Having added the indicated domain names to the set of reference domain names, the method 200 proceeds to an operation 260.

At operation 260, the method 200 determines whether to continue processing. That is to say, whether to carry out a further iteration of the method 200 in respect of a further set of candidate domain names. If so, the method 200 returns to operation 210 to repeat operations 210-250. Otherwise the method ends.

As will be appreciated by those skilled in the art, it is generally expected (but not necessary) that the method will be performed regularly, possibly on a continuous basis, so as to detect newly registered malicious domain names. In such cases, the method 200 may be performed iteratively until a shutdown or stop signal is received. The method 200 may delay before performing the next iteration, such that the method 200 is performed periodically. For example, the method may be performed every hour, every six hours, every twelve hours, every day (i.e. every twenty four hours), or every other day (i.e. every forty eight hours) or indeed at any other desired interval. The method 200 may therefore wait until a desired time interval has elapsed before repeating the method 200 to analyse all domain names that have been newly registered during that time period.

Of course, it will also be appreciated that the method 200 need not necessarily be performed iteratively, in which case no such determination needs to be made as the method 200 simply ends (and operation 250 may be omitted from the method 200 accordingly).

Furthermore, although not illustrated in FIG. 2, the method 200 may also cause (or trigger) one or more predetermined actions to be taken in respect the domain names that have been identified as being malicious (i.e. those that are indicated at operation 240) so as to mitigate or prevent a threat posed by that domain name.

As an example, the method 200 may act to prevent resolution of DNS queries for the malicious domain names coming from computer systems within a network. This may be achieved, for instance, by intercepting DNS queries (or DNS responses) to prevent a DNS response being provided to the computer system that issued it. Alternatively, the method 200 may modify the DNS response such that the computer system is not provided with the IP address associated with the malicious domain name, but with an alternative address (such as to a notification service to inform the end-user that the requested domain name is considered to be malicious).

Additionally or alternatively, the method 200 may act to block traffic from the network that is destined to the IP address(es) associated with the malicious domain names and/or block traffic from the IP address(es) associated with the malicious domain names that is destined to the network. For example, the method 200 may resolve the IP addresses that are associated with the malicious domain names and modify firewall rules for the network to prevent communication between the network and those IP addresses.

Additionally or alternatively, the method 200 may identify (e.g. by logging) any computer systems within the network that are in communication with any IP addresses associated with the indicated domain names. This may include any computer systems that attempt communication with the malicious domain name even though that communication may have been prevented (e.g. as described above).

Of course, any other suitable actions that may help to prevent or mitigate the threat posed by a malicious domain name may be taken instead of or in addition to the above-described examples.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention. It will be understood by those skilled in the art that, although the present invention has been described in relation to the above-described example embodiments, the invention is not limited thereto and that there are many possible variations and modifications which fall within the scope of the invention. The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer-implemented method for detecting malicious domain names from a set of candidate domain names based on a set of reference domain names, the method comprising:
using natural language processing to generate vector representations of the domain names, each vector representation representing a respective domain name in the set of candidate domain names and the set of reference domain names;
clustering the vector representations to generate clusters of domain names, the domain names within each cluster being similar to each other;
analysing the clusters of domain names to identify at least one cluster comprising at least one domain name belonging to the set of candidate domain names and at least one domain name belonging to the set of reference domain names; and
providing an indication of one or more of the domain names in the set of candidate domain names included in the identified clusters as being malicious domain names.

2. The method of claim 1, wherein the set of reference domain names is a set of domain names that are known to be malicious.

3. The method of claim 2, wherein the method further comprises adding the indicated domain names to the set of reference domain names for use in a future iteration of the method.

4. The method of claim 1, wherein the set of reference domain names is a set of domain names that are known to be benign.

5. The method of claim 1, wherein the set of candidate domain names is a set of domain names that have been registered within a predetermined preceding period of time.

6. The method of claim 5, wherein the set of candidate names is one of:
a set of domain names registered in the preceding hour;
a set of domain names registered in the preceding six hours;
a set of domain names registered in the preceding twelve hours;
a set of domain names registered in the preceding twenty four hours; or
a set of domain names registered in the preceding forty eight hours.

7. The method of claim 1 wherein the clustering is performed using locality sensitive hashing.

8. The method of claim 7, wherein the clustering is performed using a random projection method of locality sensitive hashing.

9. The method of claim 8, wherein a number of random projections used for clustering defines a number of buckets that is substantially greater than a total number of domain names in the set of candidate domain names and the set of reference domains.

10. The method of claim 7, wherein the method further comprises, for each of the identified clusters, analysing the domains within that cluster that belong to the set of candidate domain names to determine a respective distance between each of those candidate domain names and each of the at least one domain names belonging to the set of reference domain names within that cluster, wherein the one or more of the domain names in the set of candidate domain names that are indicated as being malicious domain names are those for which the respective distance to at least one of the domain names belonging to the set of reference domain names within that cluster is less than a predetermined threshold.

11. The method of claim 1, further comprising providing, for each of the domain names indicated as being malicious, indications of one or more, or all, of the domain names belonging to the set of reference domain names that belong to the same cluster as that domain name.

12. The method of claim 1, further comprising causing one or more predetermined actions to be taken in respect of the indicated domain names to mitigate or prevent a threat posed by that domain name.

13. The method of claim 12, wherein the one or more predetermined actions comprise one or more, or all, of:
preventing resolution of DNS queries from computer systems within a network for any of the indicated domain names;
blocking traffic from the network destined to any IP addresses associated with the indicated domain names;
blocking traffic to the network originating from any IP addresses associated with the indicated domain names; and
monitoring the network to identify any computer systems within the network that are in communication with any IP addresses associated with the indicated domain names.

14. A computer system comprising a processor and a memory storing computer program code for performing the steps of claim 1.

15. A computer program which, when executed by one or more processors is arranged to carry out a method according to claim 1.
